(19) United States
(12) Patent Application Publication
(10) Pub. No.: US 2009/0263695 A1
(43) Pub. Date: Oct. 22, 2009

(54) APPARATUS FOR GENERATING HYDROGEN AND FUEL CELL POWER GENERATION SYSTEM HAVING THE SAME

(75) Inventors: Bo-Sung KU, Suwon-si (KR); Jae-Hyuk JANG, Seoul (KR); Kyoung-Soo CHAE, Suwon-si (KR); Jae-Hyoung GIL, Seoul (KR); Chang-Ryul JUNG, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/419,095

(22) Filed: Apr. 6, 2009

(30) Foreign Application Priority Data
Apr. 21, 2008 (KR) 10-2008-0036468

(51) Int. Cl. H01M 8/18; C25B 9/00

(52) U.S. Cl. 429/21; 204/275.1

(57) ABSTRACT

Disclosed are an apparatus for generating hydrogen and a fuel cell power generation system that have the same. The apparatus in accordance with an embodiment of the present invention include: an electrolytic bath into which an electrolyte solution is injected; an anode placed inside the electrolytic bath and configured to generate an electron; a cathode placed inside the electrolytic bath and configured to generate hydrogen by receiving the electron from the anode; and a gelling agent accepted inside the electrolytic bath and configured to gel the electrolyte solution such that the fluidity of the electrolyte solution is reduced.

### CROSS-REFERENCE TO RELATED APPLICATIONS

This application claims the benefit of Korean Patent Application No. 10-2008-0036468, filed with the Korean Intellectual Property Office on Apr. 21, 2008, the disclosure of which is incorporated herein by reference in its entirety.

### BACKGROUND

1. Technical Field

The present invention relates to an apparatus for generating hydrogen and a fuel cell power generation system having the same.

2. Description of the Related Art

A fuel cell performs a function of directly converting chemical energy of fuel such as hydrogen, LNG, LPG, methanol etc., and air into electricity and heat through an electrochemical reaction. While a conventional power generation technology adopts fuel combustion, vapor generation, a turbine-driven process and a power generator-driven process, the fuel cell has neither the combustion process nor a drive device. Accordingly, the fuel cell is a new high efficiency, environmentally-friendly power generation technology.

Fuel cells being studied for application in small portable electronic devices include the Polymer Electrolyte Membrane Fuel Cell (PEMFC), which uses hydrogen as the fuel, and a direct liquid fuel cell, such as the Direct Methanol Fuel Cell (DMFC), which uses liquid fuel. Here, the Polymer Electrolyte Membrane Fuel Cell, which uses hydrogen as the fuel, has a high power density but requires a separate device for supplying hydrogen.

Methods of generating hydrogen as fuel for the Polymer Electrolyte Membrane Fuel Cell use aluminum oxidation reaction, hydrolysis of metallic borohydrides or metallic electrode reaction, among which the metallic electrode reaction method can efficiently control the hydrogen generation. Generating hydrogen through a water decomposition reaction by connecting an electron, which is obtained by ionizing an electrode of magnesium into an Mg²⁺ ion, to another metal body through a wire, the metallic electrode reaction method can control the generation of hydrogen with relation to connection/disconnection of the connected wire, a gap between the electrodes being used and the size of the electrodes.

However, depending on methods of generating hydrogen as mentioned above, the hydrogen generation may cause electrolyte solution to reversely flow to a fuel cell stack and cause an electrolytic bath to be overturned so that the electrolyte solution may leak.

### SUMMARY

The present invention provides an apparatus for generating hydrogen and a fuel cell power generation system which can prevent an electrolyte solution from reversely flowing when the hydrogen is generated, and prevent the electrolyte solution from leaking to the outside when an electrolytic bath moves.

An aspect of the present invention features an apparatus for generating hydrogen. The apparatus in accordance with an embodiment of the present invention can include: an electrolytic bath into which an electrolyte solution is injected; an anode placed inside the electrolytic bath and configured to generate an electron; a cathode placed inside the electrolytic bath and configured to generate hydrogen by receiving the electron from the anode; and a gelling agent accepted inside the electrolytic bath and configured to gel the electrolyte solution such that the fluidity of the electrolyte solution is reduced.

The gelling agent can be made of a material including a high hygroscopic resin.

The gelling agent can be made of a material including any one selected from a group consisting of sodium polyacrylate, polyacrylamide copolymer, ethylene maleic anhydride copolymer, cross-linked carboxy methyl cellulose, polyvinyl alcohol copolymer, cross-linked polyethylene oxide and starch grafted copolymer of polyacrylonitrile.

The gelling agent can be coated on the surface of any one selected from a group consisting of the electrolytic bath, the anode and the cathode.

At least one of the anode and the cathode can include a through hole formed therein such that the electrolyte solution can be evenly filled inside the electrolytic bath.

Another aspect of the present invention features a fuel cell power generation system. The system in accordance with an embodiment of the present invention can include: an electrolytic bath into which an electrolyte solution is injected; an anode placed inside the electrolytic bath and configured to generate an electron; a cathode placed inside the electrolytic bath and configured to generate hydrogen by receiving the electron from the anode; a gelling agent accepted inside the electrolytic bath and configured to gel the electrolyte solution such that the fluidity of the electrolyte solution is reduced; and a fuel cell configured to generate electrical energy by converting the chemical energy of the hydrogen generated from the cathode.

The gelling agent can be made of a material including a high hygroscopic resin.

The gelling agent can be made of a material including any one selected from a group consisting of sodium polyacrylate, polyacrylamide copolymer, ethylene maleic anhydride copolymer, cross-linked carboxy methyl cellulose, polyvinyl alcohol copolymer, cross-linked polyethylene oxide and starch grafted copolymer of polyacrylonitrile.

The gelling agent can be coated on the surface of any one selected from a group consisting of the electrolytic bath, the anode and the cathode.

At least one of the anode and the cathode can include a through hole formed therein such that the electrolyte solution can be evenly filled inside the electrolytic bath.

### BRIEF DESCRIPTION OF THE DRAWINGS

FIG. 1 is a schematic view showing an embodiment of an apparatus for generating hydrogen according to an aspect of the present invention.

FIG. 2 is a schematic view showing an embodiment of a fuel cell power generation system according to another aspect of the present invention.

### DETAILED DESCRIPTION

An embodiment of an apparatus for generating hydrogen and a fuel cell power generation system according to the present invention will be described in detail with reference to the accompanying drawings. In description with reference to accompanying drawings, the same reference numerals will be assigned to the same or corresponding elements, and repetitive description thereof will be omitted.

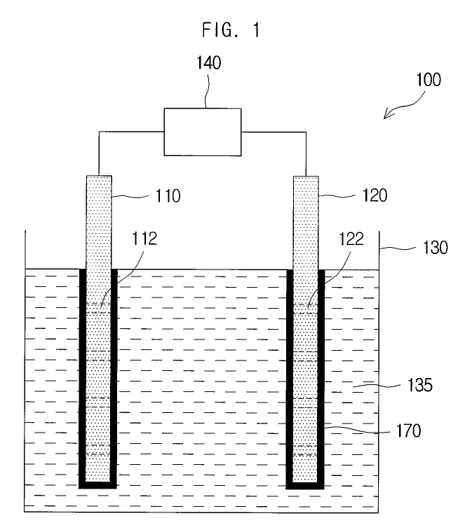

FIG. 1 is a schematic view showing an embodiment of an apparatus for generating hydrogen according to an aspect of the present invention. Illustrated in FIG. 1 are an apparatus 100 for generating hydrogen, an anode 110, a cathode 120, through holes 112 and 122, an electrolytic bath 130, an electrolyte solution 135, a controller 140 and a gelling agent 170.

According to the embodiment of the present invention, the electrolyte solution 135 is gelled by accepting the gelling agent 170 at the inside of the electrolytic bath 130 such that the fluidity of the electrolyte solution 135 can be reduced. Therefore, provided is an apparatus 100 for generating hydrogen which can prevent the electrolyte solution 135 from reversely flowing, accompanied with hydrogen when hydrogen is generated, and can prevent the electrolyte solution 135 from leaking to the outside according as the electrolytic bath 130 is overturned or tilted when the electrolytic bath 130 moves.

The electrolytic bath 130 can contain the electrolyte solution 135 which releases hydrogen through a decomposition reaction. The anode 110 and the cathode 120 are located inside the electrolytic bath 130, so that the electrolyte solution 135 contained inside the electrolytic bath 130 can bring about a hydrogen generation reaction.

LiCl, KCl, NaCl, KNO₃, NaNO₃, CaCl₂, MgCl₂, K₂SO₄, Na₂SO₄, MgSO₄, AgCl, etc can be used as the electrolyte solution 135. The electrolyte solution 135 can include a hydrogen ion. The electrolyte solution 135 can be also gelled by the gelling agent 170. This matter will be described below in the description of presenting the gelling agent 170.

The anode 110 is an active electrode, located inside the electrolytic bath 130 and can generate an electron. The anode 110 can be made of, for example, magnesium (Mg). Because of difference between ionization tendencies of the anode 110 and the hydrogen, the anode 110 can be oxidized into a magnesium ion (Mg²⁺) by releasing electrons in the electrolyte solution 135.

Here, electrons being generated can be transferred to the cathode 120. Accordingly, the anode 110 is consumed by generating electrons and configured to be replaced in a certain period of time. The anode 110 can be made of metal having a relatively higher ionization tendency than that of the cathode 120 to be described below.

The cathode 120 is an inactive electrode. Because the cathode, unlike the anode 110, cannot be consumed, it is possible to implement the cathode having thinner thickness than that of the anode 110. The cathode 120 is located inside the electrolytic bath 130 and can generate hydrogen by means of the electrons generated from the anode 110.

The cathode 120 can be made of, for example, stainless steel, and can generate hydrogen by reacting with the electrons. That is, in the chemical reaction at the cathode 120, the electrolyte solution 135 receives electrons transferred from the anode 110 and is decomposed into hydrogen at the cathode 120. The reactions of the anode and cathode are described in the following chemical equation (1).

anode 110: Mg→Mg²⁺+2e⁻

cathode 120: 2H₂O+2e⁻→H₂+2(OH)⁻

full reaction: Mg+2H₂O→Mg(OH)₂+H₂ (1)

Meanwhile, the anode 110 or the cathode 120, or both of them can have through holes 112 and 122 formed therein such that the electrolyte solution 135 to be injected into the electrolytic bath 130 can be evenly filled inside the electrolytic bath 130.

That is, since the electrolyte solution 135 is able to move through the space between the anode 110 and the cathode 120 via the through holes 112 and 122 at the time of injecting the electrolyte solution 135 into the inside of the electrolytic bath 130, it is possible to effectively and evenly fill the inside of the electrolytic bath 130 with the electrolyte solution 135 even though the electrolyte solution 135 is not directly injected into the space between the anode 110 and the cathode 120 or even though the space between the anode 110 and the cathode 120 is small and narrow.

Since the electrolyte solution 135 filled as mentioned above may be gelled simultaneously with the injection of the electrolyte solution such that the fluidity of the electrolyte solution is reduced by the gelling agent 170 to be described below, when the hydrogen is generated, it is possible to prevent the electrolyte solution 135 from being lost in company with hydrogen, and when the apparatus for generating hydrogen moves, it is possible to prevent the hydrogen from leaking to the outside according as the electrolytic bath 130 is overturned.

The controller 140 is electrically connected to the anode 110 and the cathode 120, and can control flow of electricity between the anode 110 and the cathode 120. The controller 140 receives the amount of hydrogen required by an external device such as a fuel cell and so on. If the amount is large, it is possible to increase the amount of the electrons that flow from the anode 110 to the cathode 120. If the amount is little, it is possible to decrease the amount of the electrons that flow from the anode 110 to the cathode 120.

For example, the controller 140 constituted by a variable resistor is able to control the amount of electrons flowing between the anode 110 and the cathode 120 by varying the resistance value of the variable resistor, or the electronic switch 142 constituted by an on/off switch is able to control the amount of electrons flowing between the anode 110 and the cathode 120 by controlling the on/off timing.

In order to reduce the fluidity of the electrolyte solution 135, the gelling agent 170 is accepted inside the electrolytic bath 130 and the electrolyte solution 135 can be gelled. In other words, the electrolyte solution 135 is gelled by using the gelling agent 170. Accordingly, the liquid state of the electrolyte solution 135 injected into the inside of the electrolytic bath 130 is changed into a gel state having the reduced fluidity, so that the electrolyte solution can keep a certain shape.

As the electrolyte solution 135 is gelled by using the gelling agent 170, the electrolyte solution 135 can be prevented from being released in company with hydrogen when the hydrogen is generated, so that the humidity of the hydrogen can be decreased. Simultaneously, hydrogen can be additionally generated from the electrolyte solution 135 which has been preserved without being released. Consequently, the entire amount of the generated hydrogen can be increased.

Besides, even when the direction of the electrolytic bath 130 is changed, for example, the electrolytic bath 130 is overturned or tilted when the apparatus for generating hydrogen moves, the electrolyte solution 135 can be preserved without leaking to the outside thanks to the low fluidity of the gelled electrolyte solution 135.

The gelling agent 170 can be made of a material including a high hygroscopic resin. As a result, since the gelling agent 170 having the high hygroscopic resin actively absorbs a large amount of the electrolyte solution 135, the electrolyte solution 135 and the gelling agent 170 can be as a whole in a gel state having a low fluidity.

Here, sodium polyacrylate, polyacrylamide copolymer, ethylene maleic anhydride copolymer, cross-linked carboxy methyl cellulose, polyvinyl alcohol copolymer, cross-linked polyethylene oxide and starch grafted copolymer of polyacrylonitrile or any combination of at least two of them can be used as the gelling agent 170. Thus, as described above, the gelling agent 170 absorbs a large amount of the electrolyte solution 135, so that the electrolyte solution 135 and the gelling agent 170 can be as a whole in the gel state.

Moreover, the gelling agent 170 can be coated on the surface of the electrolytic bath 130, the anode 110 and the cathode 120 or at least two of them. Thus, the surface area for reacting with the electrolyte solution 135 is expanded to more efficiently gel the electrolyte solution 135.

Next, an embodiment of a fuel cell power generation system according to another aspect of the present invention will be described.

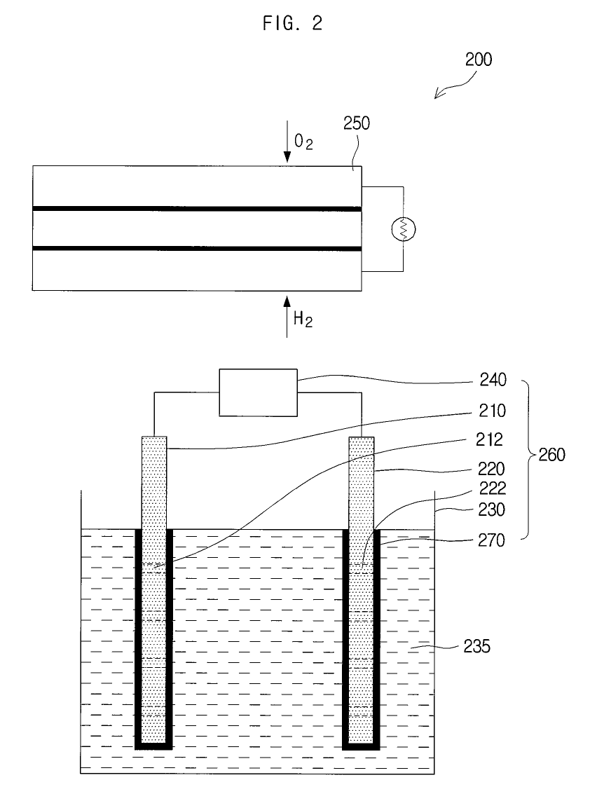

FIG. 2 is a schematic view showing an embodiment of a fuel cell power generation system according to another aspect of the present invention. In FIG. 2, illustrated are a fuel cell power generation system 200, an apparatus 260 for generating hydrogen, an anode 210, a cathode 220, through holes 212 and 222, an electrolytic bath 230, an electrolyte solution 235, a controller 240, a gelling agent 270 and a fuel cell 250.

According to the embodiment of the present invention, the gelling agent 270 is accepted inside the electrolytic bath 230 and the electrolyte solution 235 is gelled such that the fluidity of the electrolyte solution 235 is reduced, so that when hydrogen is generated, it is possible to prevent the electrolyte solution 235 from reversely flowing in company with the hydrogen, and when the electrolytic bath 230 moves, it is possible to prevent the electrolyte solution 235 from leaking to the outside according as the electrolytic bath 230 is overturned or tilted. Consequently, provided is a fuel cell power generation system 200 capable of more effectively generating electrical energy.

In the embodiment of the present invention, since the construction and operation of the apparatus 260 for generating hydrogen, the anode 210, the cathode 220, the through holes 212 and 222, the electrolytic bath 230, the electrolyte solution 235, the controller 240 and the gelling agent 270 are the same as or correspond to those of the embodiment described above, descriptions thereof will be omitted. Hereafter, a difference from the embodiment described above, that is, the fuel cell 250 will be described.

The fuel cell 250 can generate electrical energy by converting the chemical energy of the hydrogen generated by the cathode 220. The low-humidity hydrogen generated by the apparatus 260 for generating hydrogen can be transferred to the fuel electrode of the fuel cell 250. Therefore, a direct current can be generated by converting the aforesaid chemical energy of the hydrogen generated by the apparatus 260 for generating hydrogen into electrical energy.

Numerous embodiments other than embodiments described above are included within the scope of the present invention.

What is claimed is:

1. An apparatus for generating hydrogen comprising:
an electrolytic bath into which an electrolyte solution is injected;
an anode placed inside the electrolytic bath and configured to generate an electron;
a cathode placed inside the electrolytic bath and configured to generate hydrogen by receiving the electron from the anode; and
a gelling agent accepted inside the electrolytic bath and configured to gel the electrolyte solution such that the fluidity of the electrolyte solution is reduced.

2. The apparatus of claim 1, wherein the gelling agent is made of a material comprising a high hygroscopic resin.

3. The apparatus of claim 2, wherein the gelling agent is made of a material comprising any one selected from a group consisting of sodium polyacrylate, polyacrylamide copolymer, ethylene maleic anhydride copolymer, cross-linked carboxy methyl cellulose, polyvinyl alcohol copolymer, cross-linked polyethylene oxide and starch grafted copolymer of polyacrylonitrile.

4. The apparatus of claim 1, wherein the gelling agent is coated on the surface of any one selected from a group consisting of the electrolytic bath, the anode and the cathode.

5. The apparatus of claim 1, wherein at least one of the anode and the cathode comprises a through hole formed therein such that the electrolyte solution can be evenly filled inside the electrolytic bath.

6. A fuel cell power generation system comprising:
an electrolytic bath into which an electrolyte solution is injected;
an anode placed inside the electrolytic bath and configured to generate an electron;
a cathode placed inside the electrolytic bath and configured to generate hydrogen by receiving the electron from the anode;
a gelling agent accepted inside the electrolytic bath and configured to gel the electrolyte solution such that the fluidity of the electrolyte solution is reduced; and
a fuel cell configured to generate electrical energy by converting the chemical energy of the hydrogen generated from the cathode.

7. The system of claim 6, wherein the gelling agent is made of a material comprising a high hygroscopic resin.

8. The system of claim 7, wherein the gelling agent is made of a material comprising any one selected from a group consisting of sodium polyacrylate, polyacrylamide copolymer, ethylene maleic anhydride copolymer, cross-linked carboxy methyl cellulose, polyvinyl alcohol copolymer, cross-linked polyethylene oxide and starch grafted copolymer of polyacrylonitrile.

9. The system of claim 6, wherein the gelling agent is coated on the surface of any one selected from a group consisting of the electrolytic bath, the anode and the cathode.

10. The system of claim 6, wherein at least one of the anode and the cathode comprises a through hole formed therein such that the electrolyte solution can be evenly filled inside the electrolytic bath.
